(19) United States
(12) Patent Application Publication
(10) Pub. No.: US 2025/0105756 A1
(43) Pub. Date: Mar. 27, 2025

(54) THREE-LEVEL POWER SEMICONDUCTOR MODULE AND ARRANGEMENT THEREWITH

(71) Applicant: SEMIKRON DANFOSS ELEKTRONIK GMBH & CO. KG, Nuremberg (DE)

(72) Inventors: Peter BECKEDAHL, Oberasbach (DE); Oliver TAMM, Hirschaid (DE); Arendt WINTRICH, Fürth (DE)

(73) Assignee: SEMIKRON DANFOSS ELEKTRONIK GMBH & CO. KG, Nuremberg (DE)

(21) Appl. No.: 18/829,140

(22) Filed: Sep. 9, 2024

(30) Foreign Application Priority Data
Sep. 26, 2023 (DE) 10 2023 126.067.7

(51) Int. Cl. H02M 7/00; H02M 1/00; H02M 7/483

(52) U.S. Cl. CPC H02M 7/003; H02M 1/0083; H02M 7/483

(57) ABSTRACT

A three-level power semiconductor module has a housing, a switching device, a first, a second and a third DC voltage terminal element and an AC voltage terminal element, wherein respective terminal areas of the DC voltage terminal elements have an identical normal direction and are arranged next to one another in a projection in the normal direction, and wherein the third terminal area of the third DC voltage terminal element lies in a first plane and the second terminal area of the second DC voltage terminal element lies in a second plane parallel to the first plane as seen in the normal direction. An arrangement having a plurality of such three-level power semiconductor modules is provided.

### CROSS REFERENCE TO RELATED APPLICATIONS

This application relates to and claims priority to DE 10 2023 126 067.7 filed Sep. 26, 2023, the entire contents of which are incorporated herein fully by reference.

### BACKGROUND OF THE INVENTION

### Field of the Invention

The invention describes a three-level power semiconductor module having a preferably frame-like housing, having a switching device, having a first, a second and a third DC voltage terminal element and having an AC voltage terminal element, wherein respective terminal areas of the DC voltage terminal elements have an identical normal direction and are arranged next to one another in a projection in the normal direction. The invention furthermore describes an arrangement comprising a plurality of such three-level power semiconductor modules.

### Description of the Related Art

DE 10 2017 115 883 A1 discloses a submodule and an arrangement therewith, wherein the submodule comprises a switching device having a substrate and conductor tracks arranged thereon. The submodule has a first and a second DC voltage conductor track and a first and a second DC voltage terminal element electrically conductively connected thereto, as well as an AC voltage conductor track and an AC voltage terminal element electrically conductively connected thereto. The submodule furthermore comprises a moulded insulant that encloses the switching device in the manner of a frame. In this case, the first DC voltage terminal element is supported with a first contact section on a first supporting body of the moulded insulant, and the AC voltage terminal element is supported with a second contact section on a second supporting body of the moulded insulant. A first pressure device is configured to extend in an electrically insulated manner through a first recess of the first supporting body and to form an electrically conductive pressure connection between the first DC voltage terminal element and an associated first DC voltage connecting element, and a second pressure device is configured to extend in an electrically insulated manner through a second recess of the second supporting body and to form an electrically conductive pressure connection between the AC voltage terminal element and an associated AC voltage connecting element.

### ASPECTS AND OBJECTS OF THE INVENTION

At least one of the objects of the present invention is to provide an improvement over the related art.

An object of the invention is to provide a three-level power semiconductor module having three DC voltage terminal elements.

This object is achieved according to the invention by a three-level power semiconductor module having a preferably frame-like housing, having a switching device, having a first, a second and a third DC voltage terminal element and having an AC voltage terminal element, wherein respective terminal areas of the DC voltage terminal elements have an identical normal direction and are arranged next to one another in a projection in the normal direction and wherein the third terminal area of the third DC voltage terminal element lies in a first plane and the second terminal area of the second DC voltage terminal element lies in a second plane parallel to the first plane as seen in the normal direction.

It is preferential that the first terminal area of the first DC voltage terminal element lies in the second plane as seen in the normal direction. It is particularly preferential that all terminal areas lie next to one another, but not in a row, in a projection in the normal direction.

It may alternatively be preferential that the first terminal area of the first DC voltage terminal element lies in a third plane parallel to both the first and second plane as seen in the normal direction.

It may be advantageous that a first conduction section of the first DC voltage terminal element, which is immediately adjacent to the first terminal area, is flush at least in sections with the third terminal area of the third DC voltage terminal element in the normal direction. The first and the third DC voltage terminal element therefore form a stack in this region. It may furthermore be advantageous that a second conduction section of the second DC voltage terminal element, which is immediately adjacent to the second terminal area, is flush at least in sections with the third terminal area of the third DC voltage terminal element in the normal direction. The second and the third DC voltage terminal element therefore also form a stack in this region.

It may be preferential that all DC voltage terminal elements are arranged on a first narrow side of the housing. It is particularly preferential that the AC voltage terminal element is in addition arranged on a second narrow side of the housing.

It is particularly advantageous that the DC voltage terminal elements and the AC voltage terminal element are configured as a metal foil or metal sheet having a thickness of preferentially from 300 μm to 2000 μm, particularly preferentially from 500 μm to 1500 μm.

It may be advantageous that the housing respectively has a first and a second supporting area for the first and second DC voltage terminal element and a third supporting area for the third DC voltage terminal element on its first narrow side.

In addition, it may be preferential that a centrally arranged fastening recess extends through the switching device.

In a first configuration, it may be advantageous that the first DC voltage terminal element is intended to be connected to a high potential, wherein the second DC voltage terminal element is intended to be connected to a low potential and wherein the third DC voltage terminal element is intended to be connected to an intermediate potential.

In a second configuration, it may be advantageous that the first DC voltage terminal element is intended to be connected to a high potential, wherein the third DC voltage terminal element is intended to be connected to a low potential and wherein the second DC voltage terminal element is intended to be connected to an intermediate potential.

In a third configuration, it may be advantageous that the second DC voltage terminal element is intended to be connected to a high potential, wherein the third DC voltage terminal element is intended to be connected to a low potential and wherein the first DC voltage terminal element is intended to be connected to an intermediate potential.

The object is furthermore achieved by a power electronic arrangement comprising a plurality of three-level power semiconductor modules as mentioned above, wherein all three-level power semiconductor modules are arranged with their long sides next to one another in a row and wherein the DC voltage terminal elements of all power semiconductor modules are preferably likewise arranged in a row.

It may be advantageous that all respective DC voltage terminal elements are connected with a suitable polarity to common respectively associated DC voltage lead elements of a DC voltage lead device.

It may be preferential that all three-level power semiconductor modules have a common driver device. It may in this case be advantageous that each of the three-level power semiconductor modules is covered at least partially by the driver device.

It is to be understood that the various configurations of the invention may be implemented individually or in any desired combinations in order to achieve improvements. In particular, the features mentioned and explained above and below may be used not only in the combinations specified but also in other combinations or separately without departing from the scope of the present invention, regardless of whether they are disclosed in the context of the three-level power semiconductor module or of the arrangement.

Further explanations of the invention, advantageous details and features may be found in the following description of the exemplary embodiments of the invention, or respective parts thereof.

The above and other aspects, features, objects, and advantages of the present invention will become apparent from the following description read in conjunction with the accompanying drawings for exemplary but nonlimiting embodiments, in which like reference numerals designate the same elements.

### BRIEF DESCRIPTION OF THE DRAWINGS

FIGS. 1 and 2 show details of the DC voltage terminal elements and of a housing of a first configuration of the three-level power semiconductor module according to the invention.

FIG. 3 shows the first configuration of the three-level power semiconductor module according to the invention in a three-dimensional view.

FIG. 4 shows a plan view of the first configuration of the three-level power semiconductor module according to the invention.

FIG. 5 shows an arrangement according to the invention.

FIG. 6 shows a detail of the DC voltage terminal elements and of a housing of a second configuration of the three-level power semiconductor module according to the invention.

FIG. 7 shows the second configuration of the three-level power semiconductor module according to the invention in a three-dimensional view.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ or ‘bond’ or and similar terms do not necessarily denote direct and immediate connections, but also include connections through intermediate elements or devices. For purposes of convenience and clarity only, directional (up/down etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

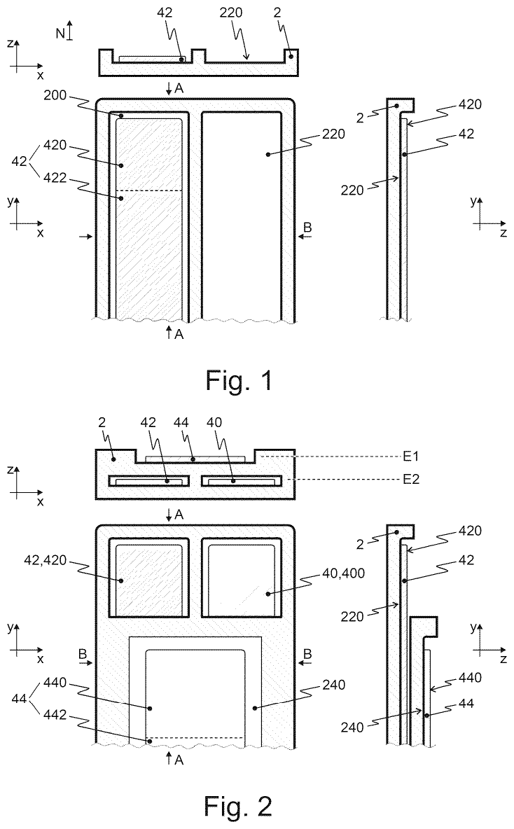

FIGS. 1 and 2 show details of the DC voltage terminal elements and of a housing of a first configuration of the three-level power semiconductor module according to the invention in three orthogonal views. For reasons of clarity, FIG. 1 shows only a part of the housing 2 and only one DC voltage terminal element 42 in this case, the terminal area 420 of which defines a normal direction N. FIG. 2 shows all DC voltage terminal elements 40,42,44, the terminal areas 400,420,440 of which all have the same normal direction N as the associated housing 2, here the z direction.

In each case, the sectional view above the plan view is taken along the line B-B and the sectional view next to the plan view is taken along the line A-A.

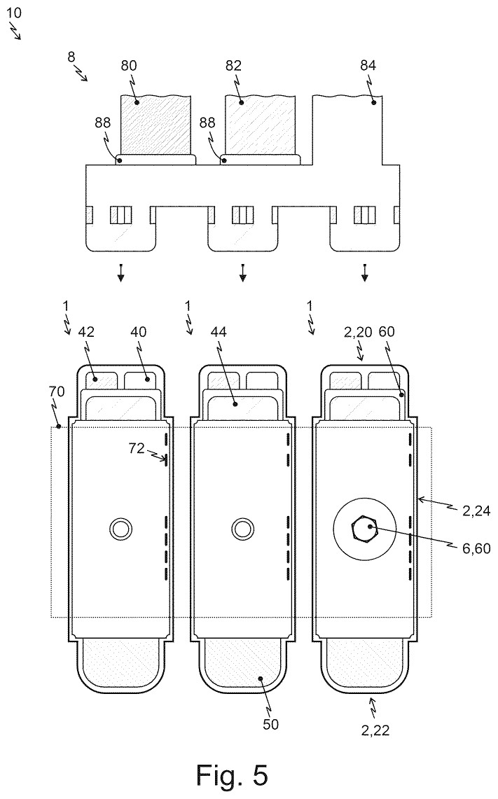

The housing 2 is configured in this case as an insulant housing, in particular a plastic housing, and respectively has a first and a second supporting area 200,220 on its first narrow side 20, cf. FIG. 3 or 5. The first DC voltage terminal element 40 is arranged on the first supporting area 200 and the second DC voltage terminal element 42 is arranged on the second supporting area 220, these supporting areas 200,220 likewise being aligned in the normal direction N. The first and the second DC voltage terminal element 40,42 are respectively arranged on one of these supporting areas 200,220. Their respective terminal areas 400,420 therefore lie in a second plane E2, where they are arranged next to one another.

The housing 2 furthermore has a third supporting area 240 for the third DC voltage terminal element 44, this third supporting area 240 also being aligned in the normal direction N. The third DC voltage terminal element 44 is arranged on this third supporting area 240 so that its third terminal area 440 is also aligned in the normal direction N. All terminal areas 400,420,440 of the DC voltage terminal elements 40,42,44 are therefore aligned in the normal direction N. In addition, the supporting area 240 of the third DC voltage terminal element 44 is set back in the negative y direction and is arranged in a first plane E1 parallel to the second plane E2, which is arranged in the negative normal direction N, i.e. also above the second plane E2 in the negative z direction. By this configuration of the housing 2 and by this arrangement of the DC voltage terminal elements 40,42,44, all three terminal areas 400,420,440 of the three DC voltage terminal elements 40,42,44 lie next to one another, but not in a row.

Consequently, a first conduction section 402 of the first DC voltage terminal element 40, which is immediately adjacent to the first terminal area 400, is flush in sections with the third terminal area 440 of the third DC voltage terminal element 44 in the normal direction N. At the same time and symmetrically therewith, a second conduction section 422 of the second DC voltage terminal element 42, which is immediately adjacent to the second terminal area 420, is flush in sections with the third terminal area 440 of the third DC voltage terminal element 44 in the normal direction N.

This configuration leads to a respective low-inductance arrangement both for the combination of the first and third DC voltage terminal element 40,44 and for the combination of the second and third DC voltage terminal element 42,44.

The housing 2, or additional insulation elements in cooperation with the housing 2, are of course configured in such a way that the respective DC voltage terminal elements are electrically insulated from one another sufficiently.

FIG. 3 shows the first configuration of the three-level power semiconductor module according to the invention in a three-dimensional schematic view. A substantially cuboid housing 2 is represented, wherein all DC voltage terminal elements 40,42,44 are arranged on its first narrow side 20 while the AC voltage terminal element 50 is arranged on a second narrow side 22. This configuration allows a very compact arrangement of a plurality of three-level power semiconductor modules next to one another, cf. FIG. 5.

The specific configuration and arrangement of the DC voltage terminal elements 40,42,44 corresponds to that according to FIG. 2.

The DC voltage terminal elements 40,42,44 and the AC voltage terminal element 50 of this three-level power semiconductor module are configured as a metal sheet with a thickness of 1 mm.

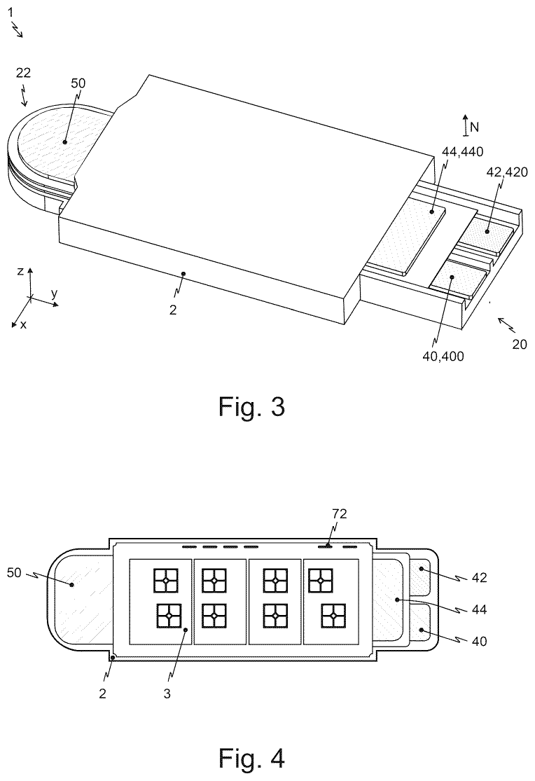

FIG. 4 shows a schematic plan view of the first configuration of the three-level power semiconductor module according to the invention. Purely by way of explanation and without specific configuration, the switching device is represented inside the housing 2. The AC voltage terminal element 50 and the DC voltage terminal elements 40,42,44, which are described in FIG. 3, are used for its electrical connection. The driving of the switching device uses auxiliary terminal elements, which are configured in particular as control terminal elements, arranged on a long side 20,22 of the housing 2 and protruding therefrom in the normal direction N.

A three-level power semiconductor module customarily in the art has three different DC potentials, namely a high potential, a low potential and an intermediate potential. As is customary in the art, the high and low potentials may be equal in magnitude but have different signs, while the intermediate potential may customarily in the art be at ground potential. In principle, each of these three potentials may be connected arbitrarily to one of the DC voltage terminal elements 40,42,44.

FIG. 5 shows an arrangement according to the invention in which three three-level power semiconductor modules 1 are arranged with their long sides 24 next to one another. In this case, the DC voltage terminal elements 40,42,44 of all three-level power semiconductor modules 1 are arranged on the same narrow side, specifically the first narrow side 20.

Three DC voltage lead elements 80,82,84 are furthermore represented, which are stacked in sections and form the DC voltage lead 8 of a capacitor device that is not represented. For reasons of clarity, the three DC voltage lead elements 80,82,84 of the three-level power semiconductor modules 1 are spaced apart. The respective DC voltage lead element 80,82,84 is connected with a suitable polarity to a respectively associated DC voltage terminal element 40,42,44.

Of course, both the DC voltage terminal elements 40,42,44 and the DC voltage lead elements 80,82,84 have an insulation device 60,88 for electrical insulation of the elements with different polarity.

Furthermore, two of the DC voltage lead elements 82,84 have recesses that are configured and intended so that a laser beam incident through these recesses from the negative normal direction N can act on a DC voltage lead element 80,82 arranged underneath. A laser welded connection formed in such a way creates a permanent material bond respectively between a DC voltage lead element 82,84 and an associated DC voltage terminal element 42,44.

Each three-level power semiconductor module 1 furthermore has auxiliary terminal elements 72, which are respectively arranged along one or both long sides 24. These auxiliary terminal elements 72 serve for electrically conductive connection of a driver device 70 common to all power semiconductor modules 1. The latter respectively covers all of the three-level power semiconductor modules 1 partially.

Each three-level power semiconductor module 1 has a centrally arranged fastening recess 6, which extends through the switching device and further components that follow in the normal direction N. A section of a fastening device 60, in particular a screw, which fixes the respective three-level power semiconductor module 1 on a cooling device, which is not represented here, preferably a liquid cooling device, is arranged in this fastening recess 6.

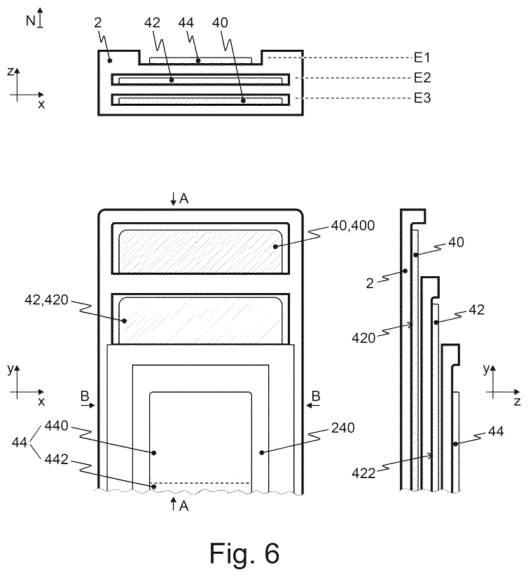

FIG. 6 shows a detail of the DC voltage terminal elements 40,42,44 and of a housing 2 of a second configuration of the three-level power semiconductor module 1 according to the invention, the respective views being selected as in FIG. 2. An essential difference here from the first configuration is the fully stacked arrangement of the DC voltage terminal elements 40,42,44, so that each of the respectively associated terminal areas 400,420,440 lies on its own plane E1,E2,E3.

Thus, the first terminal area 400 of the first DC voltage terminal element 40 lies in the third plane E3 parallel to the first and second plane as seen in the normal direction N. Likewise, all terminal areas 400,420,440 lie next to one another in a row in a projection in the normal direction N.

In this way, a second conduction section 422 of the second DC voltage terminal element 42, which is immediately adjacent to the second terminal area 420, is flush in sections with the third terminal area 440 of the third DC voltage terminal element 44 in the normal direction N. Likewise, a conduction section 402 of the first DC voltage terminal element 40, which is immediately adjacent to the first terminal area 400, is flush in sections with the second terminal area 420 of the second DC voltage terminal element 42 in the normal direction N. A conduction section 442 of the third DC voltage terminal element 44, which is immediately adjacent to the third terminal area 440, is flush in sections with the first and second conduction section 402,422 of the first and second DC voltage terminal element 42 in the normal direction N.

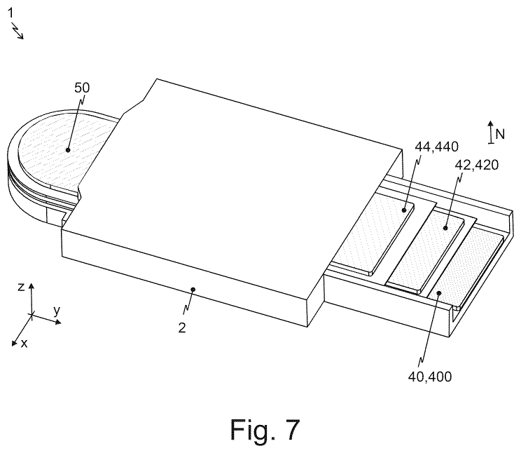

FIG. 7 shows the second configuration of the three-level power semiconductor module 1 according to the invention in a three-dimensional view. A substantially cuboid housing 2 is represented, wherein all DC voltage terminal elements 40,42,44 are arranged on its first narrow side 20 while the AC voltage terminal element 50 is arranged on a second narrow side 22. The specific configuration and arrangement of the DC voltage terminal elements 40,42,44 correspond to those according to FIG. 6.

In this second configuration of the three-level power semiconductor module 1, it is preferential but not necessary that the intermediate potential is intended to be connected to the second DC voltage terminal element 42.

Also, the inventors intend that only those claims which use the specific and exact phrase “means for” are intended to be interpreted under 35 USC 112. The structure, device, and arrangement herein is noted and well supported in the entire disclosure. Moreover, no limitations from the specification are intended to be read into any claims, unless those limitations are expressly included in the claims.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure covers modifications and variations of this disclosure provided they come within the scope of the appended claims and their equivalents.

What is claimed is:

1. A three-level power semiconductor module (1), comprising:
a frame-like housing (2), a switching device (3), a first, a second and a third DC voltage terminal element (40,42,44), and an AC voltage terminal element (50);
wherein respective terminal areas (400,420,440) of each of the DC voltage terminal elements (40,42,44) have an identical normal direction (N) and are arranged next to one another in a projection in the normal direction (N); and
wherein the third terminal area (440) of the third DC voltage terminal element (44) lies in a first plane (E1) and the second terminal area (420) of the second DC voltage terminal element (42) lies in a second plane (E2) that is parallel to the first plane as seen in the normal direction (N).

2. The three-level power semiconductor module, according to claim 1, wherein:
the first terminal area (400) of the first DC voltage terminal element (40) lies in the second plane (E2) as seen in the normal direction (N).

3. The three-level power semiconductor module, according to claim 1, wherein:
all terminal areas (400,420,440) lie next to one another, but not in a row, in a projection in the normal direction (N).

4. The three-level power semiconductor module, according to claim 1, wherein:
the first terminal area (400) of the first DC voltage terminal element (40) lies in a third plane (E3) parallel to both the first and second plane as seen in the normal direction (N).

5. The three-level power semiconductor module, according to claim 1, wherein:
a first conduction section (402) of the first DC voltage terminal element (40), which is immediately adjacent to the first terminal area (400), is flush at least in sections with the third terminal area (440) of the third DC voltage terminal element (44) in the normal direction (N).

6. The three-level power semiconductor module, according to claim 1, wherein:
a second conduction section (422) of the second DC voltage terminal element (42), which is immediately adjacent to the second terminal area (420), is flush at least in sections with the third terminal area (440) of the third DC voltage terminal element (44) in the normal direction (N).

7. The three-level power semiconductor module, according to claim 1, wherein:
each of the DC voltage terminal elements (40,42,44) are arranged on a first narrow side (20) of the housing (2).

8. The three-level power semiconductor module, according to claim 1, wherein:
the AC voltage terminal element (50) is arranged on a second narrow side (22) of the housing (2).

9. The three-level power semiconductor module, according to claim 1, wherein:
each of the DC voltage terminal elements (40,42,44) and the AC voltage terminal element (50) are configured as a metal foil or metal sheet having a thickness of preferentially from 300 μm to 2000 μm.

10. The three-level power semiconductor module, according to claim 1, wherein:
the housing (2) respectively has a first and a second supporting area (200,220) for the first and second DC voltage terminal element (40,42) and a third supporting area (240) for the third DC voltage terminal element (44) on its first narrow side (20).

11. The three-level power semiconductor module, according to claim 1, wherein:
a centrally arranged fastening recess (6) extends through the switching device.

12. The three-level power semiconductor module according to claim 1, wherein:
the first DC voltage terminal element (40) is intended to be connected to a high potential;
the second DC voltage terminal element (42) is intended to be connected to a low potential; and
the third DC voltage terminal element (44) is intended to be connected to an intermediate potential.

13. The three-level power semiconductor module according to claim 1, wherein:
the first DC voltage terminal element (40) is intended to be connected to a high potential;
the third DC voltage terminal element (44) is intended to be connected to a low potential; and
the second DC voltage terminal element (42) is intended to be connected to an intermediate potential.

14. The three-level power semiconductor module according to claim 1, wherein:
the second DC voltage terminal element (42) is intended to be connected to a high potential;
the third DC voltage terminal element (44) is intended to be connected to a low potential; and
the first DC voltage terminal element (40) is intended to be connected to an intermediate potential.

15. A power electronic arrangement (10), comprising:
a plurality of three-level power semiconductor modules (1) each of the three-level power semiconductor modules (1) according to claim 1;
wherein,
all three-level power semiconductor modules (1) are arranged with their long sides (24) next to one another in a row, and
wherein the DC voltage terminal elements (40,42,44) of all power semiconductor modules (1) are preferably likewise arranged in a row.

16. The power electronic arrangement, according to claim 15, wherein:
all respective DC voltage terminal elements (40,42,44) are connected with a suitable polarity to common respectively associated DC voltage lead elements (80,82,84) of a DC voltage lead device (8).

17. The power electronic arrangement, according to claim 15, wherein: all three-level power semiconductor modules (1) have a common driver device (70).

18. The power electronic arrangement, according to claim 17, wherein:
each of the three-level power semiconductor modules (1) is covered at least partially by the driver device (70).
